(19) United States
(12) Patent Application Publication
(10) Pub. No.: US 2013/0283157 A1
(43) Pub. Date: Oct. 24, 2013

(54) DIGITAL COMIC VIEWER DEVICE, DIGITAL COMIC VIEWING SYSTEM, NON-TRANSITORY RECORDING MEDIUM HAVING VIEWER PROGRAM RECORDED THEREON, AND DIGITAL COMIC DISPLAY METHOD

(71) Applicant: FUJIFILM Corporation, Tokyo (JP)

(72) Inventor: Tetsuro Ebata, Tokyo (JP)

(21) Appl. No.: 13/922,151

(22) Filed: Jun. 19, 2013

Related U.S. Application Data
(63) Continuation of application No. PCT/JP2011/076989, filed on Nov. 24, 2011.

(30) Foreign Application Priority Data
Dec. 22, 2010 (JP) 2010-286392

(51) Int. Cl. G06F 17/22

(52) U.S. Cl. CPC G06F 17/2264
USPC 715/265

(57) ABSTRACT

A digital comic viewer device comprising: a determination unit that determines whether or not an entire translated text corresponding to a speech balloon region in the image displayed on the screen of the display unit is fitted within the speech balloon region in a preset letter size; and a translated text display control unit that displays the translated text instead of a dialogue of an original text within the speech balloon region based on the acquired speech balloon information and text information, the translated text display control unit displaying the entire translated text in the speech balloon region when the entire translated text is fitted, and rewriting a speech balloon corresponding to the speech balloon region to a horizontally-long speech balloon and displaying the translated text in a speech balloon region of the horizontally-long speech balloon when the entire translated text is not fitted.

### CROSS-REFERENCE TO RELATED APPLICATIONS

This application is a continuation application and claims the priority benefit under 35 U.S.C. §120 of PCT Application No. PCT/JP2011/076989 filed on Nov. 24, 2011 which application designates the U.S., and also claims the priority benefit under 35 U.S.C. §119 of Japanese Patent Application No. 2010-286392 filed on Dec. 22, 2010, which applications are all hereby incorporated by reference in their entireties.

### TECHNICAL FIELD

The present invention relates to a device which displays various contents obtained by digitizing paper-based contents such as comics, newspapers, magazines, documents, textbooks, and reference books, and a method and a program thereof.

### BACKGROUND ART

Along with recent innovations in information technology, an information delivery system in which books, such as magazines and comic books, supposed to be printed on paper are digitized, and viewed on a dedicated digital book viewer such as iPad and Kindle has been established.

According to Patent Literature 1, when an original text is written vertically and a translated text is written horizontally, layout information is rotated to convert a layout to a horizontal layout.

According to Patent Literature 2, when a dialogue is not fitted within a frame of a speech balloon, the q-number of letters may be reduced, or letter spacing may be reduced.

According to Patent Literature 3, the vertical size of a block including a letter string is fixed, and only the horizontal size thereof is increased.

According to Patent Literature 4, the size of a text box is adjusted such that all letters of a dialogue inserted therein is fitted properly in vertical and horizontal directions. The vertical and horizontal lengths of the text box are adjusted according to vertical printing/horizontal printing, and a letter size.

According to Patent Literature 5, a translated text of a dialogue described in a speech balloon is displayed in a ticker region set in a display screen. The translated text in the ticker is displayed in several batches. In FIG. 10, the ticker region is set according to the position of a speech balloon in a comic image.

According to Patent Literature 6, a pattern missing generated in an original position of an image is filled with a configuration pattern of a peripheral image.

### CITATION LIST

### Patent Literature

PTL 1 Japanese Patent Application Laid-Open No. 06-96288

PTL 2 Japanese Patent Application Laid-Open No. 2006-185435

PTL 3 Japanese Patent Application Laid-Open No. 2005-056043

PTL 4 Japanese Patent Application Laid-Open No. 2005-004738

PTL 5 Japanese Patent Application Laid-Open No. 2009-098727

PTL 6 Japanese Patent Application Laid-Open No. 2000-20687

### SUMMARY OF INVENTION

### Technical Problem

Since it is empirically known that the number of letters is increased or decreased by translating a dialogue of a digital comic, the translated text may not be fitted only by rotating a speech balloon as in Patent Literature 1.

Also, dialogues in an original language and in a translated text may differ in a letter arrangement direction due to a difference in language. In this case, if a horizontal translated text in Spanish is directly fitted into a vertically-long speech balloon corresponding to Japanese arrangement as in Patent Literature 5, the translated text is likely to become difficult to read due to restrictions on a letter string in one line.

Although the dialogue may be fitted into the speech balloon by adjusting the letter size as in Patent Literature 2, it becomes difficult to read letters when the letter size becomes smaller. Particularly in a portable information terminal with a small screen size, it becomes extremely difficult to read letters when the letter size is reduced.

The layout may be rotated as in Patent Literature 1, or the size of the text box may be adjusted as in Patent Literatures 3 and 4; however, in this case, interference with an original comic drawing (the drawing is hidden or divided, a blank space is generated therein, etc.) becomes a problem, which cannot be solved simply by rotating or changing the size of an arrangement region of a dialogue.

The present invention provides a technique for drawing a speech balloon in which a letter string of a dialogue converted into any language from an original language is properly arranged in a digital comic.

### Solution to Problem

The present invention includes a digital comic viewer device including: a display unit; an information acquisition unit that acquires information of a digital comic including an image of each page or each panel of a comic, speech balloon information including information of a speech balloon region that indicates a region of a speech balloon in which a dialogue of a character of the comic is placed within the image, text information indicating a translated text obtained by translating a dialogue of a vertically-written original text within each speech balloon into a predetermined horizontally-written language, the text information being correlated with each speech balloon, and display control information enabling the image of each page or each panel to be viewed on a screen of the display unit in a scroll view or a panel view; an image display control unit that scroll-reproduces or panel-reproduces the image of each page or each panel on the screen of the display unit based on the acquired display control information; a determination unit that determines whether or not an entire translated text corresponding to a speech balloon region in the image displayed on the screen of the display unit is fitted within the speech balloon region in a preset letter size; and a translated text display control unit that displays the translated text instead of a dialogue of an original text within the speech balloon region in the image displayed on the screen based on the acquired speech balloon information and text information, the translated text display control unit displaying the entire translated text in the speech balloon region when the determination unit determines that the entire translated text is fitted, and rewriting a speech balloon corresponding to the speech balloon region to a horizontally-long speech balloon and displaying the translated text in a speech balloon region of the horizontally-long speech balloon when the determination unit determines that the entire translated text is not fitted.

The determination unit includes information of a screen size of the display unit, and determines whether or not the entire translated text corresponding to the speech balloon region in the image displayed on the screen of the display unit, the speech balloon region being displayed according to the screen size, is fitted within the speech balloon region in a preset letter size based on the information of the screen size.

The text information includes attribute information including a letter size and a font, and the translated text display control unit generates a letter for display based on the text information of the translated text and the attribute information of the letter.

The digital comic viewer device includes a letter size change unit that changes the letter size.

The digital comic viewer device includes an adjustment unit that automatically adjusts the number of lines, line spacing, or letter spacing such that the entire translated text corresponding to the speech balloon region in the image displayed on the screen of the display unit is fitted within the speech balloon region in a preset letter size and a preset unit, wherein the determination unit determines whether or not the entire translated text adjusted by the adjustment unit is fitted within the speech balloon region.

The speech balloon information includes a type of a speech balloon line, and the translated text display control unit rewrites the speech balloon to a speech balloon having a same type of line based on the type of the speech balloon line.

The speech balloon information includes positional information of a speech balloon pointer, and the translated text display control unit rewrites the speech balloon to a speech balloon having a speech balloon pointer at a same position based on the positional information of the speech balloon pointer.

The information of the digital comic includes existence region information indicating a region of a character in the image, and the translated text display control unit rewrites the speech balloon to a speech balloon so as not to overlap with the region of the character based on the existence region information.

The translated text display control unit draws an image analogized from a peripheral image of a region with no image newly generated by rewriting the speech balloon in the region.

The translated text display control unit fills a region with no image newly generated by rewriting the speech balloon with a white or background-color image.

The present invention includes a digital comic viewing system including a user terminal including a function of the viewer device described above, and a server that provides the information of the digital comic according to a request from the user terminal.

The present invention includes a viewer program achieving the viewer device described above, and a non-transitory computer-readable recording medium having the viewer program recorded thereon.

The present invention includes a digital comic display method causing a digital comic viewer device including a display unit to execute: a step of acquiring information of a digital comic including an image of each page or each panel of a comic, speech balloon information including information of a speech balloon region that indicates a region of a speech balloon in which a dialogue of a character of the comic is placed within the image, text information indicating a translated text obtained by translating a dialogue of a vertically-written original text within each speech balloon into a predetermined horizontally-written language, the text information being correlated with each speech balloon, and display control information enabling the image of each page or each panel to be viewed on a screen of the display unit in a scroll view or a panel view; a step of scroll-reproducing or panel-reproducing the image of each page or each panel on the screen of the display unit based on the acquired display control information, a step of determining whether or not an entire translated text corresponding to a speech balloon region in the image displayed on the screen of the display unit is fitted within the speech balloon region in a preset letter size; and a step of displaying the translated text instead of a dialogue of an original text within the speech balloon region in the image displayed on the screen based on the acquired speech balloon information and text information, and, in the step, displaying the entire translated text in the speech balloon region when it is determined that the entire translated text is fitted, and rewriting a speech balloon corresponding to the speech balloon region to a horizontally-long speech balloon and displaying the translated text in a speech balloon region of the horizontally-long speech balloon when it is determined that the entire translated text is not fitted.

### Advantageous Effects of Invention

In accordance with the present invention, when the translated text is not fitted within the vertically-long speech balloon, the vertically-long speech balloon is rewritten to the horizontally-long speech balloon, and the translated text is displayed in the horizontally-long speech balloon. Accordingly, the letter string of the dialogue converted into any language from an original language can be properly arranged within the speech balloon in a digital comic.

### BRIEF DESCRIPTION OF DRAWINGS

FIG. 1 is a schematic configuration diagram of a content delivery system.

FIG. 2 is a concept explanatory view of a content file.

FIG. 3A is a view illustrating one example of information regarding the shape of a speech balloon (normal).

FIG. 3B is a view illustrating one example of information regarding the shape of a speech balloon (loud voice).

FIG. 3C is a view illustrating one example of information regarding the shape of a speech balloon (imagination).

FIG. 3D is a view illustrating one example of information regarding the shape of a speech balloon (inanimate object).

FIG. 4 is a flowchart of a delivery process.

FIG. 5 is a flowchart of a display process (scroll view).

FIG. 6 is a flowchart of a display process (panel view).

FIG. 7 is a flowchart of a dialogue process.

FIG. 8A is a view illustrating one example of drawing of a speech balloon (vertical).

FIG. 8B is a view illustrating one example of drawing of a speech balloon (horizontal).

FIG. 9 is a view illustrating one example of information regarding voice reproduction corresponding to a displayed detailed image.

### DESCRIPTION OF EMBODIMENTS

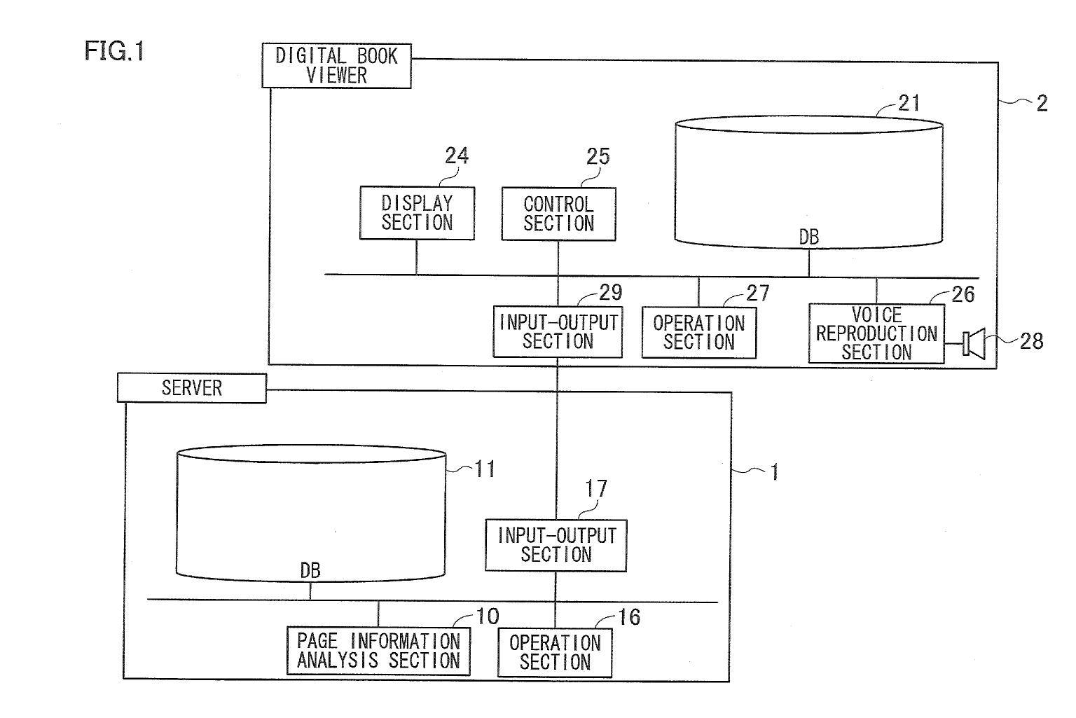

FIG. 1 shows a configuration of a content delivery system according to a preferred embodiment of the present invention. The system includes a server 1 and a digital book viewer 2. The server 1 is composed of a computer (information processor) including an arithmetic device (CPU), a memory device that stores programs and data required for operating the arithmetic device, an input-output circuit, or the like.

The digital book viewer 2 is an information terminal including display unit capable of reproducing an image, communication unit, an arithmetic device (CPU), a memory device, an input-output circuit, operation unit, voice reproduction unit capable of reproducing a voice, or the like, and is composed of, for example, a smartphone or a tablet computer. An unspecified large number of digital book viewers 2 may access the server 1.

To be more specific, the server 1 includes a page information analysis section 10, a database (DB) 11, an operation section 16, and an input-output section 17.

The page information analysis section 10 is composed of an information processor such as a CPU. The DB 11 is composed of a memory medium such as a hard disk and a memory. The operation section 16 is operation unit such as a keyboard, a mouse, and a touch pad.

The DB 11 accumulates content files that store content images correlated with page numbers and their accompanying information in a predetermined file format. The content image is obtained by digitizing an original content by a scanner or the like. The original content, such as comics, newspapers, articles in weekly magazines, office documents (presentation documents, etc.), textbooks, and reference books, is set in units of pages. The original content image is also correlated with the page number.

The content image and its accompanying information may be saved in any format, and are saved in an XML file or the like. The accompanying information may be recorded on the original content image. The accompanying information may include a content author, a title, the total number of pages, a volume number, an episode number, the holder of the right of publication (a publisher), or the like.

The content image includes a schematic image, and a detailed image (high-definition data), which are respectively prepared for each page, panel, or anchor point.

The accompanying information accompanying the content image includes information input from the operation section 16, information on an analysis result by the page information analysis section 10, or information input via the input-output section 17.

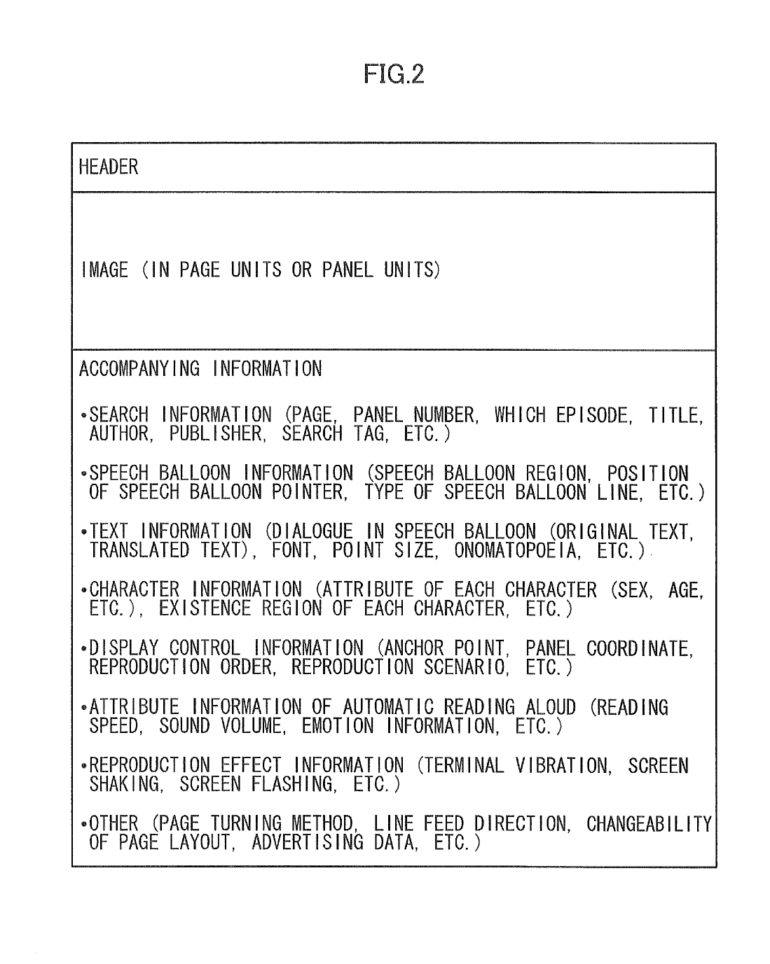

FIG. 2 is a concept explanatory view of the content file. The content file includes both of a content file for a scroll view including a schematic image for each page and a detailed image corresponding to each anchor point in the page, and a content file for a panel view including a schematic image for each page, and a detailed image for each panel. Although the digital comic information is composed of one file in the present embodiment, the digital comic information may be composed of a plurality of files by storing the content image and the accompanying information in separate files.

A header indicates a file attribute (file name, etc.).

The accompanying information is composed of search tag information, speech balloon information, text information, character information, display control information, attribute information of automatic reading aloud, reproduction effect information, page information, and other information.

Search tag information: The search tag information is tag information used for searching. Examples thereof may include information such as a page number (page identification information), a panel number (panel identification information), an episode number (episode identification information indicating, for example, which episode), a title, an author, a publisher (the holder of the right of publication), and the total number of pages.

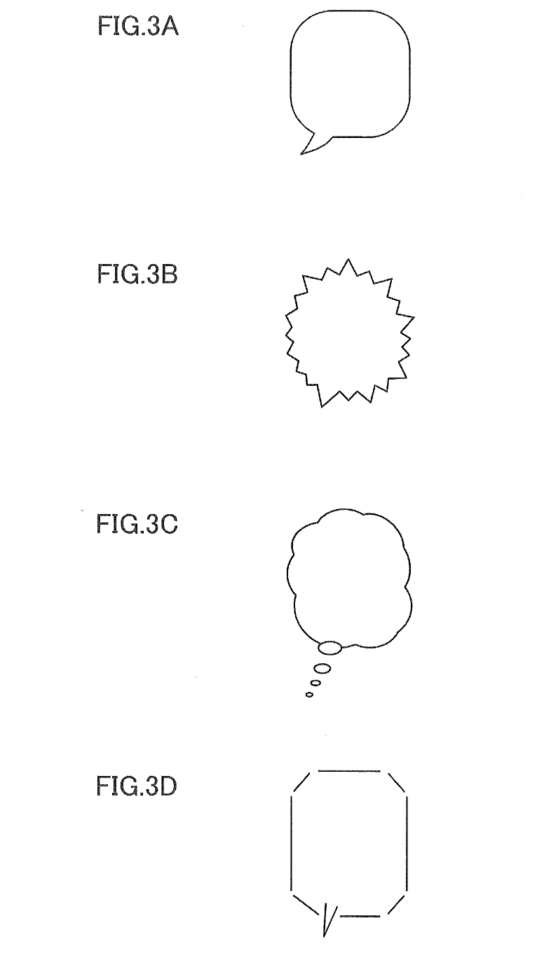

Speech balloon information: The speech balloon information is information regarding a speech balloon in the content image in units of pages (or in units of panels). Examples thereof include speech balloon region information indicating an existence region of a speech balloon within the content image, the shape of the speech balloon, the position and direction of a starting point of the speech balloon (a pointer of the speech balloon), a line attribute (dotted line, solid line, etc.) of the speech balloon, a relative positional relationship between an element (speaker, etc.) of the content image and the starting point of the speech balloon (e.g., a minimum interval between the pointer of the speech balloon and a speaker's face indicated by the pointer of the speech balloon), the size of the speech balloon, identification information of a speaker of the speech balloon, and a panel to which the speech balloon belongs. The speech balloon region information is, for example, information indicating the position of a line (frame line) of the speech balloon within the content image (e.g., positional information of a plurality of points on the line corresponding to the shape of the speech balloon, or vector information of the entire line). The speech balloon region information may be bitmap information indicating an entire region (range) of the speech balloon. The speech balloon region information may be also represented by a specific position (center position) of the speech balloon and the size of the speech balloon. For example, when there are four types of speech balloons as shown in FIGS. 3A to 3D, identification information A to D respectively corresponding to the speech balloons are stored as the line attributes of the speech balloons.

Text information: The text information is information regarding a text within the content image. Examples thereof include a text (sentence), letter attribute information, the number of lines, line spacing, letter spacing, a display switching method, a used language, and discrimination of vertical writing/horizontal writing or a reading direction corresponding to each panel and each speech balloon. The letter attribute information includes a letter size (point size, etc.) and a letter class (font, emphasized letter, etc.). A dialogue of a speaker in a speech balloon is included in the text information. A translated text in various languages and its used language (the translated text may be translated into two or more languages) corresponding to a dialogue in an original text arranged within a speech balloon may be also included in the text information. A text arranged outside of a speech balloon (narration, letter string indicating an onomatopoeia, etc.), a translated text thereof and an attribute of the text (letter size, font, text decoration, etc.), and reading-aloud attributes thereof (volume, speed, repeat count, start/end timings, etc.) may be further included in the text information. The display switching method may include a scrolling speed, a scrolling direction, and a scrolling method such as a method for starting, ending, suspending, and repeating scrolling.

Character information: The character information is information regarding a speaker of a dialogue in a speech balloon. Examples thereof include speaker region information (face region information, etc.) indicating an existence region of a speaker (character) within the content image (the schematic image and the detailed image), identification information of the speaker (name, etc.), and an attribute of the speaker (sex, age, etc.). The speaker unit a generation source of a dialogue (speech) in a speech balloon, and includes not only humans, but also animals, and inanimate objects such as phones, personal computers, electronic devices, and robots.

The display control information is information regarding display control in units of pages or in units of panels. This information also includes screen scrolling and/or screen switching. The screen scrolling information may include a scrolling speed, a scrolling direction, a scrolling order, and a method for starting, ending, suspending, and repeating scrolling as detailed information. The screen switching information may include a unit of switching (panel, etc.), a method for determining a switching timing (manual, automatic, semiautomatic), and a display effect (wiping, fading in/fading out, dissolving) accompanying switching as detailed information.

Attribute information of automatic reading aloud: Examples thereof include a reading speed, a sound volume, and speaker's emotion.

The display control information includes a reproduction scenario. The reproduction scenario includes an enlargement factor of a detailed image as a unit of a partial display region of the content image, a display switching speed and a display switching method (scrolling, fading out/fading in, etc.) from a detailed image corresponding to a previous anchor point to a detailed image corresponding to a next anchor point, a stay time as a gaze stopping time length at each anchor point or each panel, that is, a display time length of a detailed image corresponding to each anchor point, ranks (page, section) of a schematic image and a detailed image in the content, a transition order of anchor points, header information, or the like. The anchor point unit a position (eye stop) at which gaze stops within a partial region of an image of each page (typically, a panel or a portion of a panel).

The reproduction scenario includes a stay time suitable for a text amount in the detailed image corresponding to each anchor point. When there is a larger text amount in the detailed image around each anchor point, there is correspondingly a larger amount of information in one screen. Thus, the stay time is correspondingly set to be longer in the reproduction scenario.

Alternatively, the enlargement factor of the detailed image at each anchor point is set in the digital book viewer 2 accessing the server 1, or a stay time for each model suitable for the screen size of each model is set in the reproduction scenario.

Alternatively, the display switching speed between the anchor points is set in the reproduction scenario. The speed may be determined based on a past viewing speed acquired as reproduction state information corresponding to a user of the digital book viewer 2 accessing the server 1, or may be determined by applying past viewing speeds acquired as reproduction state information from a plurality of digital book viewers 2 reproducing the same reproduction content to a predetermined arithmetic expression (average, etc.).

The display switching method may be determined according to an instruction from a user of the digital book viewer 2 to an operation section 27, may employ a predetermined default switching method, or may be set based on content analysis information. For example, when the gaze of a character in the content within a panel a is directed toward a panel b to which the anchor point is moved, the display switching method from the panel a to the panel b is set to scrolling.

Information regarding a reading voice: Examples thereof include a content of a reading voice, start/end timings, a reading speed, a reading voice volume, and an attribute of a reading speaker (sex, age, etc.). The content of the reading voice may be a recorded voice, or an artificial voice. When the content of the reading voice is an artificial voice, the content can be shared with a content of a speech balloon and/or an accompanying voice.

Page information: Examples thereof include opening from left/opening from right, and a line feed direction (in a case of vertical writing).

Information regarding an accompanying voice: Examples thereof include a content of an onomatopoeia or a sound effect (text information of an original text and a translated text), the number of appearances, an appearance panel, a volume, a start timing/end timing, a speed, and a sound volume. The onomatopoeia may be acquired from the content image by the page information analysis section 10, or may be input from the input-output section 17 or the like. For example, letter information not included in a speech balloon is acquired as the content of the onomatopoeia. A translated text in various languages corresponding to the onomatopoeia may be also included in the information.

Information regarding a reproduction effect: Examples thereof include the type and start timing of an effect such as terminal vibration, screen shaking, screen flashing, and screen switching.

Changeability information indicates whether a layout can be changed, such as enlarging of a screen.

Other information: Examples thereof include a page margin region and advertising data arranged in the region. The changeability information included in the other information is setting information indicating whether the original content can be modified, such as whether the layout can be changed. For example, the information indicates whether translation display, speech balloon enlargement, change in speech balloon shape, image change, reading aloud of a dialogue or an onomatopoeia, left-right reversal of an entire page are allowed. Whether the original content can be modified can be independently set with respect to each modification item. For example, it may be set such that translation display is allowed, but left-right reversal of an entire page is prohibited. It may be also set that scroll reproduction (scroll view) is allowed, but panel reproduction (panel view) is prohibited. Alternatively, the other information includes page information such as information regarding page turning (e.g., opening from left/opening from right), and a line feed direction (in a case of vertical writing).

The page information analysis section 10 analyzes the content images accumulated in the DB 11. Information acquired as a result of analysis is provided as the accompanying information. For example, the information regarding a page analysis result includes a layout of content elements (panels, drawings, character types in the drawings, speech balloons, dialogues, texts, tables, figures, etc.) in each page, a reading order of the content elements, character features (character name, character's gaze direction, character's size and position, etc.), a content of a text such as a dialogue, the position and amount (the number of letters) thereof, page/section/chapter, etc. break, or the like.

A known image analysis technique or text analysis technique is used to analyze and acquire the page information by the page information analysis section 10. For example, the position, size, and type of a content element such as a face, an animal, a building, an automobile, and other objects may be automatically detected based on a feature amount regarding image information thereof. The content element may be automatically detected based on machine learning For example, the accuracy of detecting an outer edge of a panel or a speech balloon, and a determination threshold value for the validity of a region other than a rectangular region as a panel or a speech balloon is empirically set based on a sample comic for learning.

Alternatively, a text sentence (dialogue) within a speech balloon may be recognized by OCR, and a region surrounding the text sentence may be recognized as a dialogue region. Respective letters of a read-out dialogue are sorted according to a letter direction. For example, when the dialogue is written vertically, the letters are sorted from the top to the bottom of a line, and also from a right line to a left line.

A panel number or a dialogue number is determined according to a predetermined rule. For example, when the type of the content is a comic, the page number or the dialogue number is determined by sequentially scanning representative points (the center or gravity center of a panel or a speech balloon) of respective panels or respective speech balloons included in the content analysis info ration in a horizontal direction from a panel or a speech balloon at a right topmost position to a panel or a speech balloon at a left bottommost position.

The representative point of each panel is provided as a position (anchor point) at which gaze stops for a content element in each page. Content display is switched in units at the anchor point by scrolling or switching

Alternatively, although not shown in the drawings, the page number or the dialogue number may be determined according to a rule for an author of the content.

Alternatively, the content analysis rule may not be only a prescribed rule according to the author or type of the content, but also a rule according to the author or type of the content learned by artificial intelligence.

For example, the rule is learned as follows. First, a correct rule is preliminarily prepared for each of a plurality of basic patterns. The page information analysis section 10 extracts a feature amount (thickness or length of a panel border line, etc.) for each of the plurality of basic patterns. The page information analysis section 10 estimates a reading order of panels assumed by a content creator based on the extracted feature amount. The page information analysis section 10 optimizes a parameter for estimating the reading order of panels by comparing the reading order estimated for each basic pattern and the correct rule. The page information analysis section 10 estimates a reading order of panels of a comic according to the optimized parameter.

For the simplicity of explanation, the original content is assumed to be a comic, and the original content image is assumed to be an image corresponding to each page of the comic. The comic unit a content composed of both pictures (irrespective of photographs or drawings) and dialogues.

Referring again to FIG. 1, the digital book viewer 2 is composed of a portable information terminal such as a smartphone and a tablet computer, and includes display unit capable of reproducing an image, communication unit, operation detection unit, voice reproduction unit, an information processor, or the like.

To be more specific, the digital book viewer 2 includes a database (DB) 21, a display section 24, a content display control section 25, a voice reproduction section 26, an operation section 27, a loudspeaker 28, and an input-output section 29.

The display section 24 is display unit composed of a display device such as an LCD. The operation section 27 is operation detection unit composed of a touch panel or the like. The operation section 27 is preferably laminated on the display section 24, and can detect various operations on the display section 24 such as single tapping, double tapping, swiping, and pressing and holding.

The voice reproduction section 26 is a circuit that creates a voice from information regarding a voice (information regarding a reading voice and/or information regarding an accompanying voice) stored in a content file, and outputs the voice from the loudspeaker 28.

The input-output section 29 is unit for inputting a content file output from the input-output section 17 of the server 1. The input-output section 17 and the input-output section 29 are typically communication unit. The input-output sections may be also writing/reading unit with respect to a recording medium readable by a computer.

The DB 21 stores information equivalent to that of the DB 11. That is, when the digital book viewer 2 requests transmission of a digital book to the server 1, the server 1 exports a content file in the DB 11 to the DB 21 via the input-output section 29, and stores the content file in the DB 21. The information in the DB 11 and the information in the DB 21 do not need to be completely the same as each other. The DB 11 is a library that stores various types of content images, e.g., content images of respective volumes of comics by different authors so as to respond to requests from various users. It is enough for the DB 21 to store only a content file relevant to a content that a user of the digital book viewer 2 wants to view.

The content display control section 25 performs display control of the content on the display section 24. The control will be described in detail later.

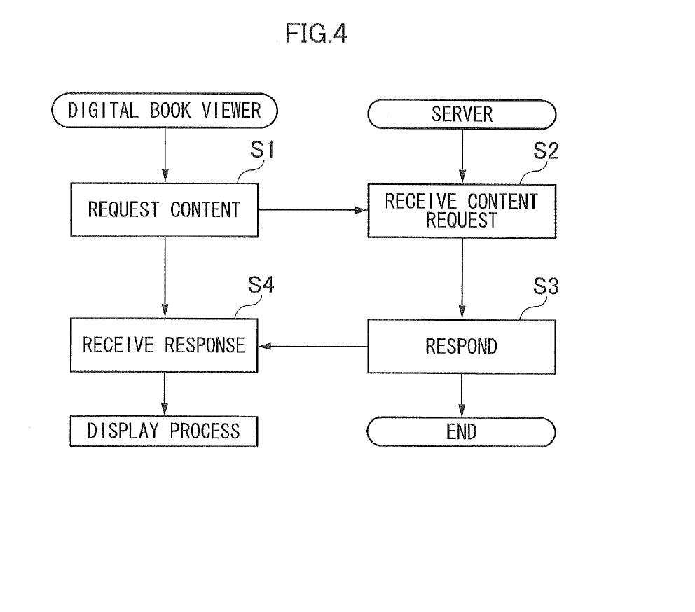

FIG. 4 shows a flowchart of a delivery process executed between the server 1 and the digital book viewer 2. Steps Si and S4 are executed by the digital book viewer 2, and steps S2 and S3 are executed by the server 1. A program that allows the server 1 and the digital book viewer 2 to respectively execute the process is stored in a memory medium (RAM, ROM, CDROM, etc.) readable by a computer provided in each of the server 1 and the digital book viewer 2.

In step S1, the digital book viewer 2 transmits a content request to the server 1 via the input-output section 29.

In step S2, the server 1 waits for a content request corresponding to a scroll view or a panel view, and when the server 1 receives the content request from the digital book viewer 2 via the input-output section 17, the process proceeds to step S3.

In step S3, the server 1 transmits a content file to the digital book viewer 2. That is, when there is a content request corresponding to the scroll view, the server 1 transmits a content file corresponding to the scroll view, and when there is a content request corresponding to the panel view, the server 1 transmits a content file corresponding to the panel view.

In step S4, the digital book viewer 2 receives the content file, and stores the content file in the DB 21. The process then proceeds to a display process described below. Content images may be transmitted in units of pages or units of panels, and as for accompanying information, only information corresponding to the units of the transmitted content images may be transmitted.

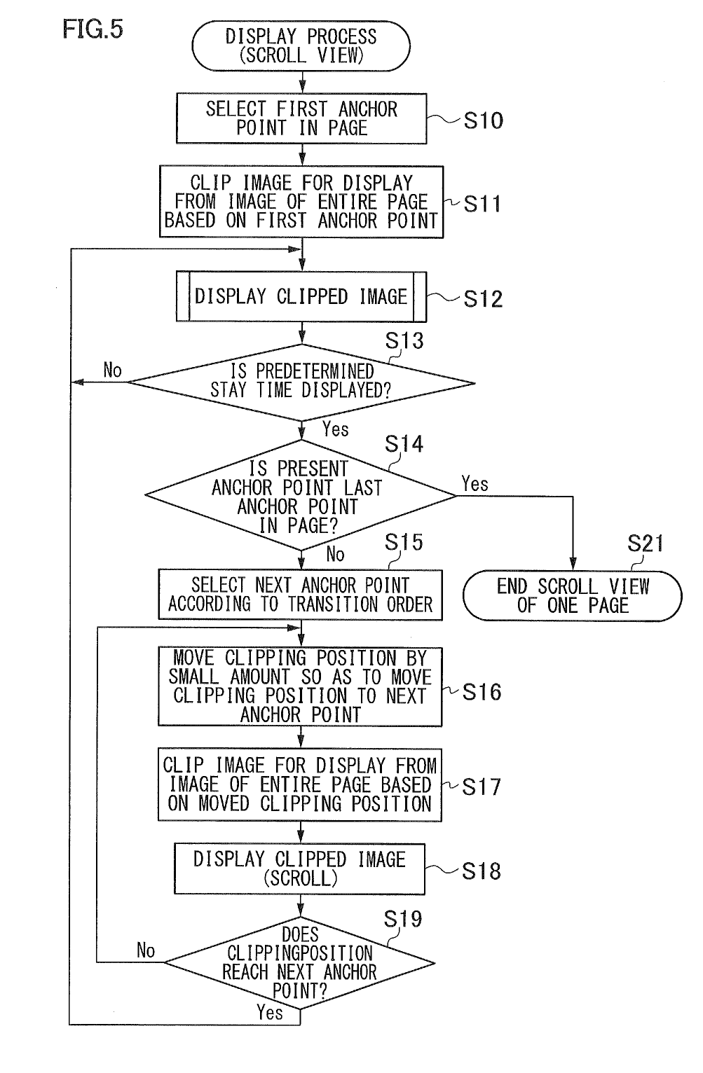

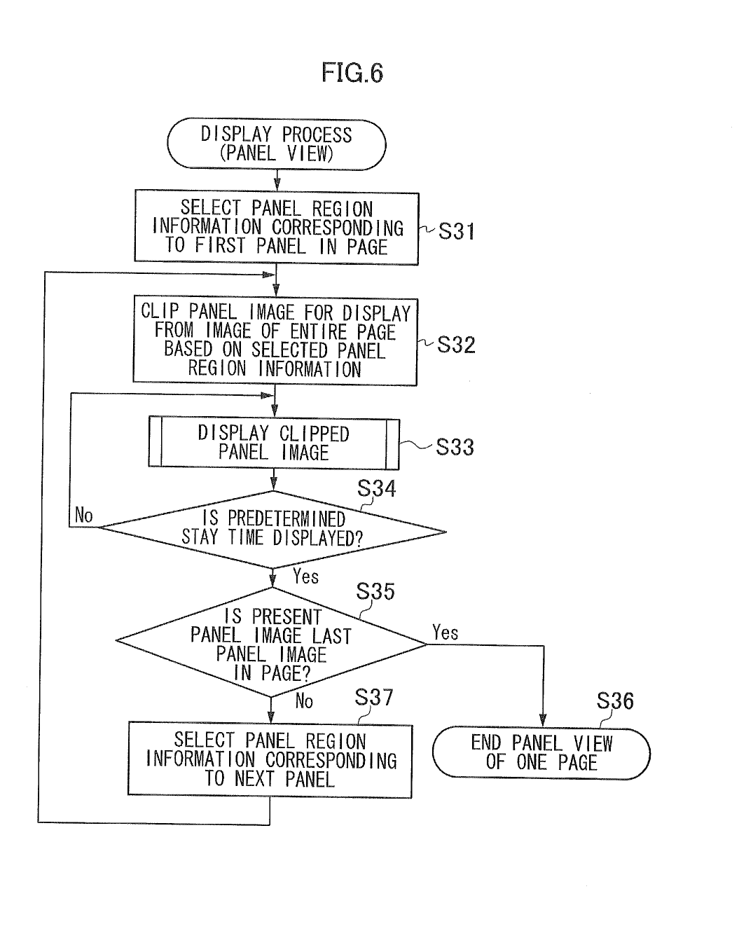

FIG. 5 shows a flowchart of the display process (scroll view) executed by the digital book viewer 2. FIG. 6 shows a flowchart of the display process (panel view) executed by the digital book viewer 2. The process in FIG. 5 or 6 is executed according to selection from the operation section 27.

Referring to FIG. 5, in step S10, the content display control section 25 sets a first anchor point in a page with a specified content image as a current anchor point based on the content file in the DB 21.

In step S11, the content display control section 25 clips a detailed image for display from a schematic image of the entire page based on the current anchor point, and employs the detailed image as a current image. A detailed image of the content file may be read out and employed as a current image instead of clipping the detailed image.

In step S12, the content display control section 25 displays the detailed image on the display section 24.

In step S13, the content display control section 25 determines whether or not a stay time corresponding to the current anchor point has been passed based on the accompanying information of the content file in the DB 21. In a case of Yes, the process proceeds to step S14, and in a case of No, the process returns to step S12.

In step S14, the content display control section 25 determines whether or not the current anchor point is a last anchor point in the page. In a case of Yes, the process proceeds to step S21 to terminate display of the page. If there is a next page, steps from S10 are repeated for the page. In a case of No, the process proceeds to step S15.

In step S15, the content display control section 25 sets, as a tentative anchor point, a position incremented in predetermined units (e.g. dot by dot) from the current anchor point along a line segment connecting the current anchor point and a next anchor point. The increment is repeated by the number of loops from S16 to S19.

In steps S16 and S17, the content display control section 25 clips a detailed image for display from the image of the entire page based on the tentative anchor point, and employs the detailed image as a next detailed image. A detailed image of the content file may be also used instead of clipping the image.

In step S18, the content display control section 25 switches the detailed image corresponding to the present tentative anchor point to a detailed image corresponding to a next tentative anchor point, and displays the detailed image. As a result, the screen is scrolled in predetermined units.

In step S19, the content display control section 25 determines whether or not the tentative anchor point reaches the anchor point next to the current anchor point. In a case of Yes, the process returns to step S12 to employ the next anchor point as a new current anchor point, and display a detailed image corresponding to the current anchor point. In a case of No, the process returns to step S16 to continue scrolling in predetermined units.

Referring to FIG. 6, in step S31, the content display control section 25 sets a first panel as a current panel based on a panel order in a content image of a specified page.

In step S32, the content display control section 25 clips a detailed image corresponding to the current panel from the content image, and employs the detailed image as a current panel image. A detailed image of the content file may be also used instead of clipping the detailed image.

In step S33, the content display control section 25 displays the current panel image on the display section 24.

In step S34, the content display control section 25 determines whether or not a stay time corresponding to the current panel has been passed based on the accompanying information of the content file. In a case of Yes, the process proceeds to step S35, and in a case of No, the process returns to step S33.

In step S35, the content display control section 25 determines whether or not the current panel is a last panel in the page. In a case of Yes, the process proceeds to step S36 to terminate display of the page. If there is a next page, steps from S31 are repeated for the page. In a case of No, the process proceeds to step S37.

In step S37, the content display control section 25 sets a panel next to the current panel as a new current panel. The process then returns to step S32 to clip a detailed image corresponding to the current panel, or read out a detailed image, and employ the detailed image as a current panel image. The steps thereafter are the same as described above.

In step S12 or S33, the image may be switched according to an image feed instruction input to the operation section 27. The image is switched in units of anchor points (S12) or units of panels (S33). Also, the image is switched according to the anchor point order or the panel order. Since a user may desire irregular viewing such as skipping of pages, a content-image switching operation disregarding the order may be allowed.

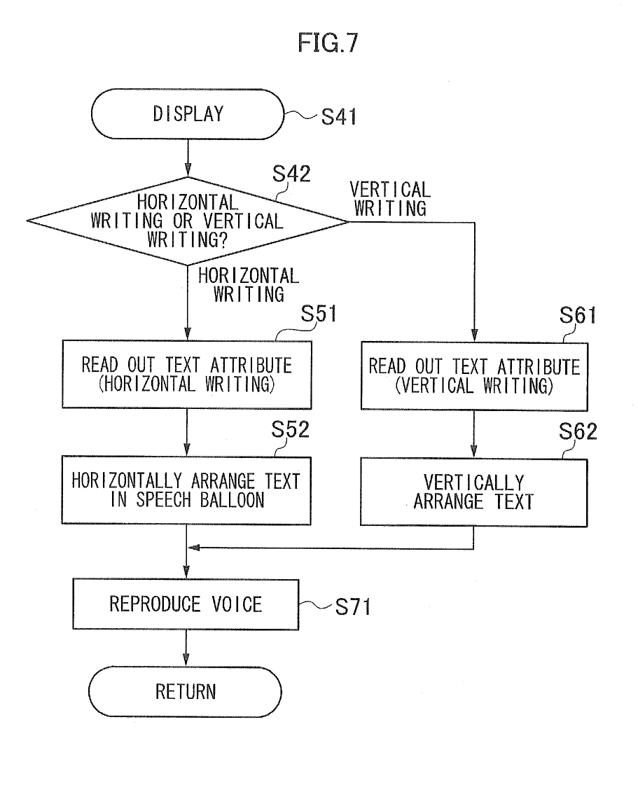

FIG. 7 shows a flowchart of a dialogue process executed by the digital book viewer 2. The process is executed in conjunction with step S12 or S33.

In step S41, the content display control section 25 starts displaying the content image based on the content file in the DB 21. The step is similar to step S12 or S33.

In step S42, the content display control section 25 determines whether “horizontal writing” is instructed or “vertical writing” is instructed as a dialogue display direction in a speech balloon. When there is an instruction of “horizontal writing”, the process proceeds to step S51, and when there is an instruction of “vertical writing”, the process proceeds to step S61.

In step S51, the content display control section 25 reads out information of a speech balloon corresponding to an image region specified to be displayed, a text attribute (size, font, letter spacing, line spacing, the number of lines, etc.) included in text information of a horizontal dialogue (translated text) corresponding to the speech balloon, and information of a character as a speaker of the speech balloon.

In step S52, the content display control section 25 displays the specified image region on the page display section 24. The content display control section 25 also determines whether or not the text information is fitted within the speech balloon when arranged horizontally according to the read-out text attribute. The text attribute includes at least a letter size. The content display control section 25 determines whether or not the text information is fitted within the speech balloon while maintaining the letter size according to screen size information of the display section 24 (stored in the DB 21).

When determining that the text information is fitted, the content display control section 25 draws a speech balloon for vertical placement from the speaker of the speech balloon corresponding to the image region specified to be displayed.

When determining that the text information is not fitted, the content display control section 25 further determines whether or not a layout can be changed based on the accompanying information, and when the layout can be changed, draws a speech balloon for horizontal placement from the speaker of the speech balloon corresponding to the image region specified to be displayed.

The speech balloon to be drawn has an enough size for the read-out text information to be arranged horizontally according to the text attribute. The type of a line of the speech balloon to be drawn is the same as an original line. A starting point of the speech balloon to be drawn is close to a starting point of the original speech balloon to indicate the same speaker as the starting point. This is because the speaker of the speech balloon remains the same even when the dialogue is translated. Also, the speech balloon is drawn at a position other than the positions of characters and the positions of other speech balloons such that the positions do not overlap with the speech balloon to be drawn.

The content display control section 25 horizontally arranges letters in the drawn speech balloon according to the read-out text information and text attribute of the dialogue. When the layout cannot be changed, the content display control section 25 reduces the letter size of the horizontal text, or adjusts the number of lines, line spacing, or letter spacing to arrange the horizontal text in the original speech balloon.

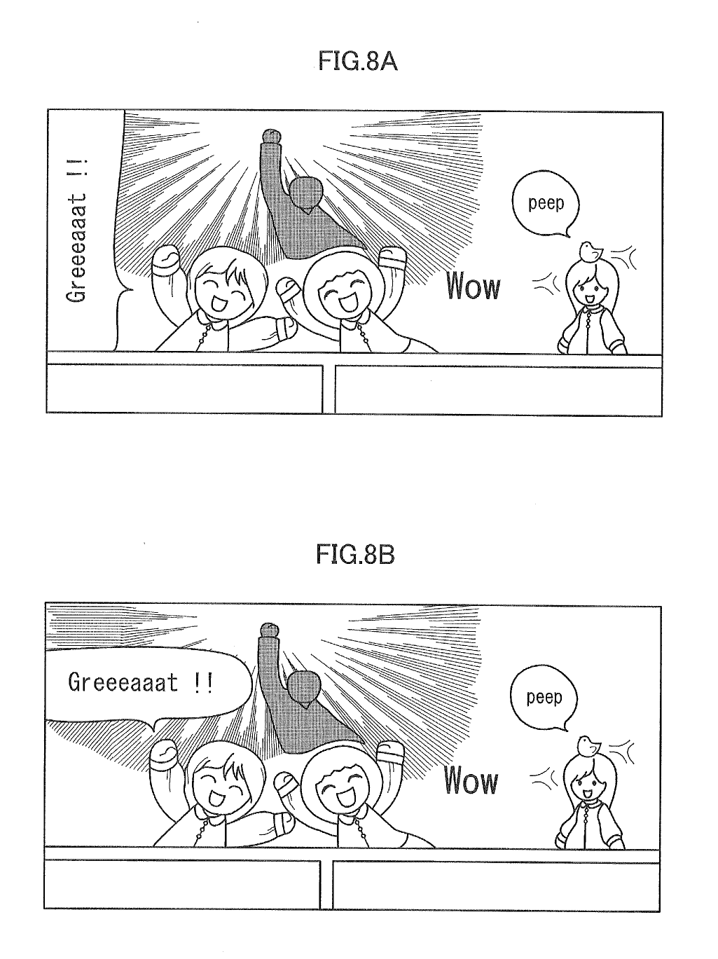

For example, it is assumed that there is an instruction of horizontal placement with respect to an original content having a vertically-placed Japanese dialogue “Ii!!” as shown in FIG. 8A. When horizontally-written text information is not fitted within a speech balloon for vertical placement, a speech balloon is drawn in such a size that a horizontal translated text in English “Great!!” corresponding to the Japanese text “Ii!!” is fitted in a specified size (the letter size specified in the text attribute, or a size smaller than the letter size within a range not falling below a predetermined limit value) as shown in FIG. 8B. The Japanese text itself, not the translated text, or a language other than English may be written horizontally.

The content display control section 25 deletes image information of a region having the speech balloon corresponding to the original vertically-written dialogue in conjunction with drawing of the speech balloon corresponding to the horizontally-written dialogue in the speech balloon, and thereby generates a blank region with no image information.

The content display control section 25 fills the blank region with peripheral image information. This is performed by detecting pixel information or image pattern around the blank region, such as pattern, gradation, line segment, and coloring, and duplicating or extending the pixel information or image pattern. When the peripheral pixel information or pixel pattern cannot be detected, the blank region is filled with a predetermined color such as white.

In step S61, the content display control section 25 reads out positional information of a speech balloon corresponding to an image region specified to be displayed, text information and a text attribute of a vertical dialogue (original text) corresponding to the speech balloon, and information of a character as a speaker of the speech balloon.

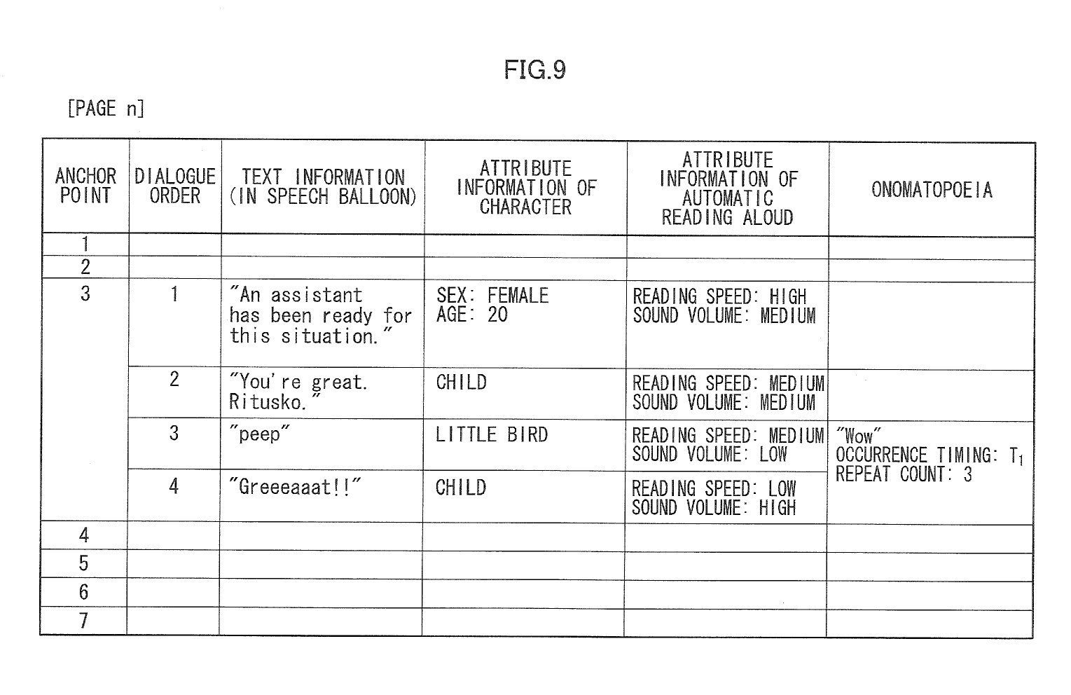

In step S62, the content display control section 25 vertically arranges the text information of the dialogue according to the text attribute within the speech balloon based on the positional information of the speech balloon (see FIG. 9).

In step S71, the voice reproduction section 26 reproduces a voice based on information regarding a voice.

First, the voice reproduction section 26 determines a dialogue corresponding to the detailed image presently displayed by the content display control section 25, a voice corresponding to the dialogue, and an accompanying voice corresponding to a panel to which the dialogue belongs, and acquires information regarding voice reproduction (text information, attribute information of a character, attribute information of automatic reading aloud, onomatopoeia) from the accompanying information.

FIG. 9 shows one example of the information regarding voice reproduction corresponding to the displayed detailed image (anchor point 3).

The voice reproduction section 26 identifies an attribute of a dialogue voice from the information regarding voice reproduction, and outputs a voice corresponding to the attribute from the loudspeaker 28. For example, when the attribute indicates that the age of a dialogue speaker is 15, and the sex of the dialogue speaker is female, the voice reproduction section 26 synthesizes a dialogue voice with an attribute of a preset early-teen female voice, and outputs the dialogue voice from the loudspeaker 28.

When the dialogue voice has no attribute due to such reasons that a speaker is not important (appears only one time, etc.), a speaker has no personality, and the like, the dialogue voice is synthesized with a default attribute.

Also, when there is no attribute regarding a reading volume or a reading speed, the dialogue voice is synthesized based on an attribute of a speech balloon in which the corresponding dialogue is arranged, or an attribute of the dialogue.

For example, when the type of the speech balloon represents a dialogue in a loud voice as shown in FIG. 3B, the voice reproduction section 26 sets the reading volume of the dialogue to “high”. Alternatively, when the type of the speech balloon represents a dialogue indicating imagination or remembrance as shown in FIG. 3C, the voice reproduction section 26 sets the reading volume of the dialogue to “low”. Alternatively, when the type of the speech balloon is other than those in FIGS. 3B and 3C, the voice reproduction section 26 sets the reading volume of the dialogue to “medium”.

Alternatively, when letters of the dialogue include an emphasized letter or a mark “!”, the voice reproduction section 26 sets the reading volume of the dialogue to “high”.

Alternatively, when the letter spacing of the dialogue is “large”, the voice reproduction section 26 sets the reading speed of the dialogue to “slow”, and when the letter spacing of the dialogue is “small”, the voice reproduction section 26 sets the reading speed of the dialogue to “quick”.

Here, the voice reproduction section 26 creates a voice in the same language as the language of the dialogue arranged in the speech balloon. However, if a different language from the language of the speech balloon is specified by the operation section 27, the voice reproduction section 26 creates a voice in the language.

Starting/ending of display of the dialogue in the speech balloon is synchronized with starting/ending of reading aloud of the dialogue in the speech balloon. For example, if the reading order of speech balloons is included in the information regarding a speech balloon, dialogues in the speech balloons are read aloud according to the order. At this point, a visual effect may be applied to dialogue letters in synchronization with reproduction of the dialogue being read aloud. For example, as the visual effect on the dialogue letters, the individual letters of a dialogue being read aloud may be highlighted, or decorated with underline, dot, and color, only a dialogue portion being read aloud may be shown by scrolling, the individual letters of a dialogue not being read aloud may be grayed out, or a dialogue which has been already read aloud may be faded out.

When the start/end timings of an accompanying voice are specified in the information regarding an accompanying voice, the accompanying voice is reproduced according to the timings When the timings are not specified, starting/ending of reading aloud of the dialogue in the speech balloon are also synchronized with starting/ending of the accompanying voice in a panel to which the speech balloon belongs. For example, when there are letters “Wow” in the background, a corresponding cheer is reproduced from the starting to the ending of display of a detailed image in which the letters are included.

When the same accompanying voice is arranged over a plurality of panels, the voice reproduction section 26 continuously reproduces the accompanying voice by, for example, repeating the accompanying voice from the starting to the ending of display of the panels.

As described above, when the content file of the present invention is provided to the digital book viewer 2, the digital book viewer 2 can arrange a dialogue and perform scrolling according to the language of the dialogue, and can reproduce a voice of the dialogue, an onomatopoeia and a sound effect.

A program that allows the content delivery system, the server 1, and the digital book viewer 2 to execute the respective processes in FIGS. 4 to 7 is recorded on a recording medium, such as the DB 11 and the DB 21, readable by a computer.

### REFERENCE SIGNS LIST

1 Server
2 Digital book viewer

1. A digital comic viewer device comprising:
a display unit;
an information acquisition unit that acquires information of a digital comic including an image of each page or each panel of a comic, speech balloon information including information of a speech balloon region that indicates a region of a speech balloon in which a dialogue of a character of the comic is placed within the image, text information indicating a translated text obtained by translating a dialogue of a vertically-written original text within each speech balloon into a predetermined horizontally-written language, the text information being correlated with each speech balloon, and display control information enabling the image of each page or each panel to be viewed on a screen of the display unit in a scroll view or a panel view;
an image display control unit that scroll-reproduces or panel-reproduces the image of each page or each panel on the screen of the display unit based on the acquired display control information;
a determination unit that determines whether or not an entire translated text corresponding to a speech balloon region in the image displayed on the screen of the display unit is fitted within the speech balloon region in a preset letter size; and
a translated text display control unit that displays the translated text instead of a dialogue of an original text within the speech balloon region in the image displayed on the screen based on the acquired speech balloon information and text information, the translated text display control unit displaying the entire translated text in the speech balloon region when the determination unit determines that the entire translated text is fitted, and rewriting a speech balloon corresponding to the speech balloon region to a horizontally-long speech balloon and displaying the translated text in a speech balloon region of the horizontally-long speech balloon when the determination unit determines that the entire translated text is not fitted.

2. The digital comic viewer device according to claim 1, wherein the determination unit includes information of a screen size of the display unit, and determines whether or not the entire translated text corresponding to the speech balloon region in the image displayed on the screen of the display unit, the speech balloon region being displayed according to the screen size, is fitted within the speech balloon region in a preset letter size based on the information of the screen size.

3. The digital comic viewer device according to claim 1, wherein the text information includes attribute information including a letter size and a font, and the translated text display control unit generates a letter for display based on the text information of the translated text and the attribute information of the letter.

4. The digital comic viewer device according to claim 1, comprising a letter size change unit that changes the letter size.

5. The digital comic viewer device according to claim 1, comprising an adjustment unit that automatically adjusts the number of lines, line spacing, or letter spacing such that the entire translated text corresponding to the speech balloon region in the image displayed on the screen of the display unit is fitted within the speech balloon region in a preset letter size and a preset unit,
wherein the determination unit determines whether or not the entire translated text adjusted by the adjustment unit is fitted within the speech balloon region.

6. The digital comic viewer device according to claim 1, wherein the speech balloon information includes a type of a speech balloon line, and
the translated text display control unit rewrites the speech balloon to a speech balloon having a same type of line based on the type of the speech balloon line.

7. The digital comic viewer device according to claim 1, wherein the speech balloon information includes positional information of a speech balloon pointer, and
the translated text display control unit rewrites the speech balloon to a speech balloon having a speech balloon pointer at a same position based on the positional information of the speech balloon pointer.

8. The digital comic viewer device according to claim 1, wherein the information of the digital comic includes existence region information indicating a region of a character in the image, and
the translated text display control unit rewrites the speech balloon to a speech balloon so as not to overlap with the region of the character based on the existence region information.

9. The digital comic viewer device according to claim 1, wherein the translated text display control unit draws an image analogized from a peripheral image of a region with no image newly generated by rewriting the speech balloon in the region.

10. The digital comic viewer device according to claim 1, wherein the translated text display control unit fills a region with no image newly generated by rewriting the speech balloon with a white or background-color image.

11. A digital comic viewing system comprising
a user terminal including a function of a viewer device according to claim 1, and
a server that provides the information of the digital comic according to a request from the user terminal.

12. A digital comic display method causing a digital comic viewer device including display unit to execute:
a step of acquiring information of a digital comic including an image of each page or each panel of a comic, speech balloon information including information of a speech balloon region that indicates a region of a speech balloon in which a dialogue of a character of the comic is placed within the image, text information indicating a translated text obtained by translating a dialogue of a vertically-written original text within each speech balloon into a predetermined horizontally-written language, the text information being correlated with each speech balloon, and display control information enabling the image of each page or each panel to be viewed on a screen of the display unit in a scroll view or a panel view;
a step of scroll-reproducing or panel-reproducing the image of each page or each panel on the screen of the display unit based on the acquired display control information;
a step of determining whether or not an entire translated text corresponding to a speech balloon region in the image displayed on the screen of the display unit is fitted within the speech balloon region in a preset letter size; and
a step of displaying the translated text instead of a dialogue of an original text within the speech balloon region in the image displayed on the screen based on the acquired speech balloon information and text information, and, in the step, displaying the entire translated text in the speech balloon region when it is determined that the entire translated text is fitted, and rewriting a speech balloon corresponding to the speech balloon region to a horizontally-long speech balloon and displaying the translated text in a speech balloon region of the horizontally-long speech balloon when it is determined that the entire translated text is not fitted.

13. A non-transitory computer-readable recording medium having a viewer program causing a digital comic viewer device to execute the digital comic display method according to claim 12.
